(19) United States
(12) Patent Application Publication
(10) Pub. No.: US 2013/0290116 A1
(43) Pub. Date: Oct. 31, 2013

(54) INFINITE WHEEL USER INTERFACE

(71) Applicants: Guy Hepworth, San Francisco, CA (US); Craig Douglas Weber, Menlo Park, CA (US); Peter Matthew Klein, Cupertino, CA (US); Aparna Jain, Mountain View, CA (US)

(72) Inventors: Guy Hepworth, San Francisco, CA (US); Craig Douglas Weber, Menlo Park, CA (US); Peter Matthew Klein, Cupertino, CA (US); Aparna Jain, Mountain View, CA (US)

(73) Assignee: Yahoo! Inc., Sunnyvale, CA (US)

(21) Appl. No.: 13/458,976

(22) Filed: Apr. 27, 2012

(51) Int. Cl. G06F 3/048; G06Q 30/02

(52) U.S. Cl. 705/14.73; 715/784

(57) ABSTRACT

Disclosed is a system for a content wheel displayed on a graphical user interface (GUI) for scrolling through a set of content. The content wheel can present various types of content for which the user can view and interact. The content wheel provides a circular scrolling path for which a user's gestures are tracked. As the content wheel is spun, the content is programmatically changed. This allows continual visual interaction with the associated content and creates a visibly stunning interaction for the user. Additionally, there can be any number of content items displayed on the content wheel, as the school wheel's display and functionality allows for scalability of the interactive and displayed content.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever

### FIELD

The present disclosure relates generally to identifying inputs on a graphical user interface, and more particularly to identifying inputs and adjusting displayable items within a graphical user interface in response to a rotation of a displayed and interactive content wheel.

### SUMMARY

The present disclosure addresses failings in the art by providing a content wheel displayed on a graphical user interface (GUI) for scrolling through a set of content. The content wheel can present various types of content for which the user can view and interact. The content wheel provides a circular scrolling path (or region) for which a user's gestures are tracked. As the content wheel is spun, the displayed content is programmatically changed. This allows continual visual interaction with the associated content and creates a visibly stunning interaction for the user. Additionally, there can be any number of content items displayed on the content wheel, as the school wheel's display and functionality allows for scalability of the interactive and displayed content.

In accordance with one or more embodiments, a graphical user interface is visibly displayed on computing device. The graphical user interface can be operative to visibly displaying a graphical user interface on a display of a computing device, the graphical user interface displaying a radially oriented first plurality of interface elements; receiving, via the computing device, user input to scroll said first plurality of interface elements; scrolling, via the computing device, said first plurality of interface elements based on the user input, said scrolling resulting in the display displaying the first plurality of interface elements as appearing to be rotating along a circumferential path; and visibly displaying a radially oriented second plurality of interface elements, the display of the second plurality of interface elements resulting in the visual appearance that the first plurality of interface elements have rotated from a first position to a second position about a fixed axis of rotation.

In accordance with one or more embodiments, a non-transitory computer-readable storage medium is provided, the computer-readable storage medium tangibly storing thereon, or having tangibly encoded thereon, computer readable instructions that when executed cause at least one processor to securely, effectively and conveniently assemble and deliver communications to provide a content wheel displayed on a GUI for scrolling through content.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an computing device in accordance with some embodiments of the present disclosure;

FIG. 2 is a flow chart of an exemplary touch screen process in accordance with some embodiments of the present disclosure;

FIGS. 3A-3F are examples of a graphical user interface displaying a content wheel in accordance with some embodiments of the present disclosure;

FIG. 4 is a schematic diagram illustrating an example of a network within which the systems and methods disclosed herein could be implemented according to some embodiments of the present disclosure; and

FIG. 5 is a block diagram illustrating an internal architecture of an example of a computing device according to some embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended.

Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense. The Detailed Description is not intended as an extensive or detailed discussion of known concepts, and as such, details that are known generally to those of ordinary skill in the relevant art may have been omitted or may be handled in summary fashion.

The systems and methods to which this disclosure relates are described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure, a computer-readable medium (or computer-readable storage medium/media) stores computer data, which data can include computer program code that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM (random access memory), ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For purposes of this disclosure, an electronic computing device, electronic device or computing device (also referred to as a client device or user device) may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

An electronic device may include or may execute a variety of operating systems, including a personal computer operating system, such as a WINDOWS°, iOS® or LINUX®, or a mobile operating system, such as iOS®, ANDROID®, or WINDOWS MOBILE®, or the like. An electronic device may include or may execute a variety of possible applications, such as a client software application enabling communication with other devices, such as communicating one or more messages, such as via email, short message service (SMS), or multimedia message service (MMS), including via a network, such as a social network, to provide only a few possible examples. An electronic device may also include or execute an application to communicate content, such as, for example, textual content, multimedia content, or the like. An electronic device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

According to some exemplary embodiments, the electronic device used herein is a touch sensor device, referred to as a touch device. A touch device is a device that typically includes a sensing region that uses capacitive, resistive, inductive, optical, acoustic or other technology to determine the presence, input (or depression), proximity, location and/or motion of one or more fingers, styli, pointers, and/or other objects. The touch device can be operated via input with one or more fingers styli, pointers and/or other objects, and can be used to provide an input to the electronic system, such as a desktop, tablet, notebook computer and smartphone, as well as kiosks and other terminals. As understood in the art, the touch device receives input not only when a user's finger(s) contacts the display screen of the touch device, but also when the user's finger(s) or other object(s) is within a detected proximity to the display screen of the touch device. Thus, the sensing region of the touch device can function as a cursor control/pointing device, selection device, scrolling device, graphics/character/handwriting input device, menu navigation device, gaming input device, button input device keyboard and/or other input device.

Although the embodiments discussed herein are described with reference to a touch device, other embodiments exist where the device is a computing device comprises, or is coupled to, a display screen where inputs are registered via a pointer (via a mouse), keyboard entry, or other inputs generally understood to register commands on a traditional computing device.

In addition, as discussed herein, exemplary embodiments include a GUI displayed on a touch device. However, it should be understood that any array of electronic devices can be used. Such devices, referred to as a client (or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like, as discussed above.

In various embodiments, the touch device provides a GUI for controlling a visual computing environment that represents programs, files, and options with graphical images, such as icons, menus and dialog boxes on the display screen of the touch device. Graphical items defined within the GUI can provide software routines which are handled by the GUI. Therefore, the GUI can report and act upon a user's actions respective of the graphical items. A GUI is a window, all of or a defined area of a display that contains distinguishable text, graphics, video, audio and other information for output. A display area may contain multiple windows that are associated with a single software program or multiple software programs executing concurrently. When multiple graphical objects are displayed concurrently, the graphical objects can overlap. The order in which the graphical objects are drawn on top of on another onscreen to simulate depth is typically known as the z-order. Those objects at the top of the z-axis obscure the view, partially or wholly, of those graphical object drawn below.

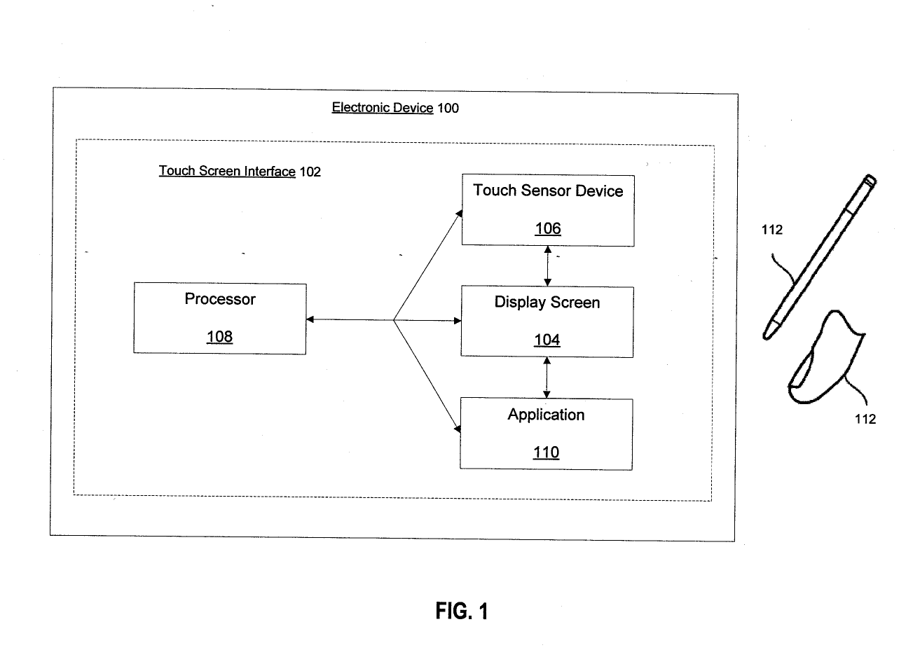

The touch device can employ a touch screen interface, as discussed in FIG. 1 below. The touch screen interface combines the functionality of the GUI displayed on the display screen of with the touch device with the touch device's capabilities to recognize a sensed input. With most sensing technologies (e.g. capacitive, resistive, and inductive), a touch sensor is stacked with the display screen and sensor elements (e.g. electrodes) are located above, below, or within the display screen elements. Other technologies (e.g. surface acoustic wave and optical) may position the sensor elements elsewhere, but at least part of the sensing region overlaps with the display screen. The resulting combination is usually referred to together as a “touch screen.” A touch screen can provide a multi-purpose interface that can function both as a display and as an input device. Furthermore, because virtual touch screen controls can replace some physical input controls, the touch screen can extend to areas of a device typically reserved for other input devices.

In accordance with some embodiments, a touch screen interface is used to provide scrolling in response to a scroll gesture (or object motion). In some embodiments, the scroll gesture/object motion may be recognizable only along a path or region indicated by a graphically displayed “wheel”. In other embodiments, the “wheel” can recognize any scroll gesture/object motion effectuated with the touch screen interface. Within the present disclosure, a graphically displayed “wheel” of input elements can be referred to as a “content wheel”. According to some exemplary embodiments, the content wheel is provided by a downloadable application. Therefore, the downloaded application, in accordance with the exemplary embodiments, renders a content wheel on the GUI, thereby providing the touch screen interface with the functionality provided by the downloaded application. Other embodiments may exist where the content wheel is provided by the touch device, web-based provider and/or operating system running on the touch device.

In some embodiments, implementations exist where the touch screen interface provides scrolling and visual feedback in response to user input. The discussed embodiments related to the content wheel herein can provide solutions to common user interface problems associated with traditional scrolling methods. For example, users are not confined to specific scrolling tracks at set locations, and no longer need to follow the exact paths of physical separate scroll paths. Additionally, less space is required since there are no separate input devices devoted to scrolling; thus, more space can be devoted to the touch screen interface and non-scrolling functions, e.g., providing content viewable to the user. Furthermore, the touch screen interface enabled with a content wheel can provide more visual feedback than one merely providing content in a list.

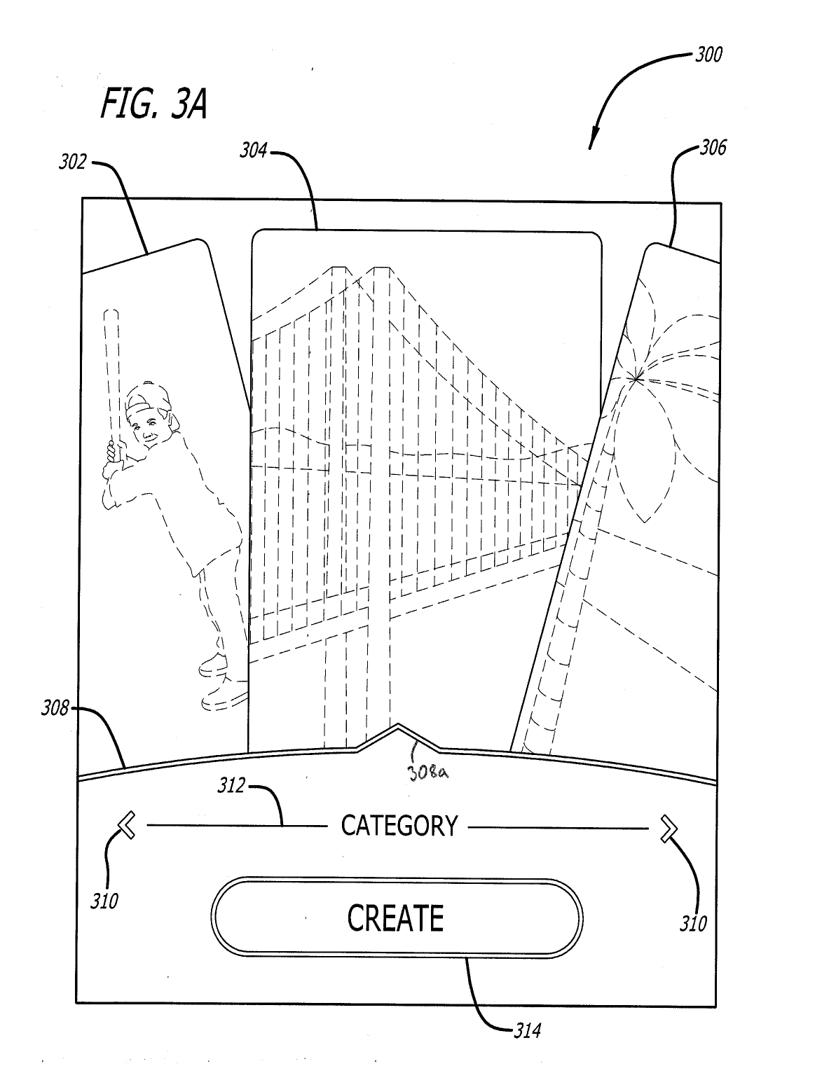

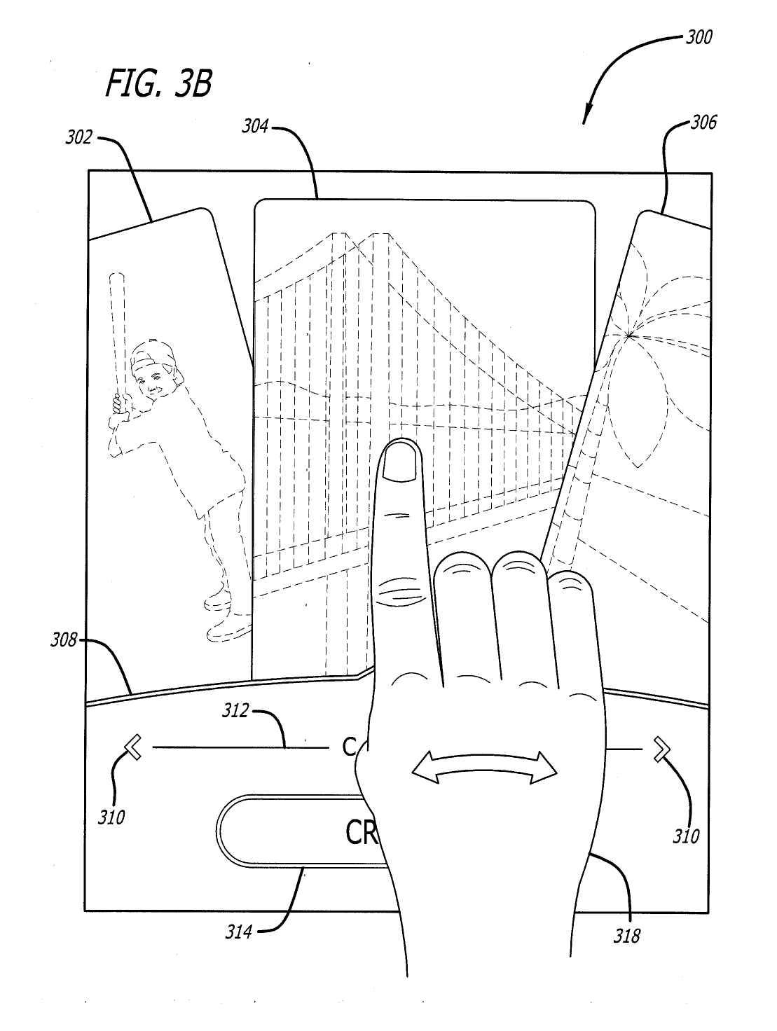

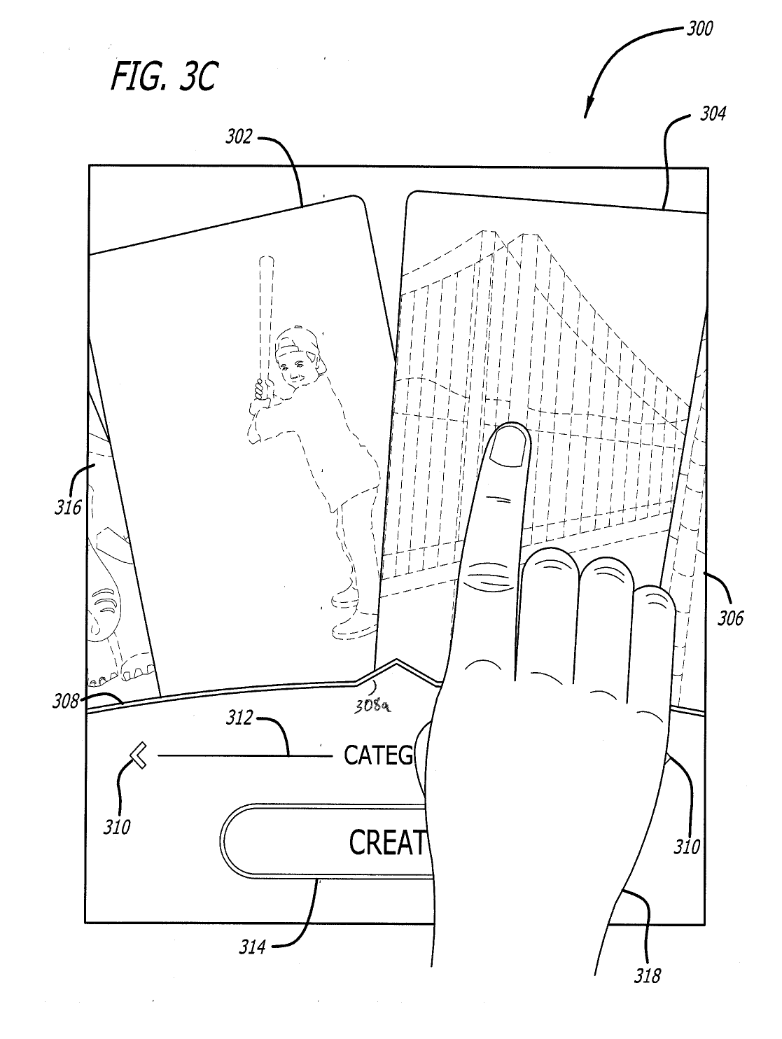

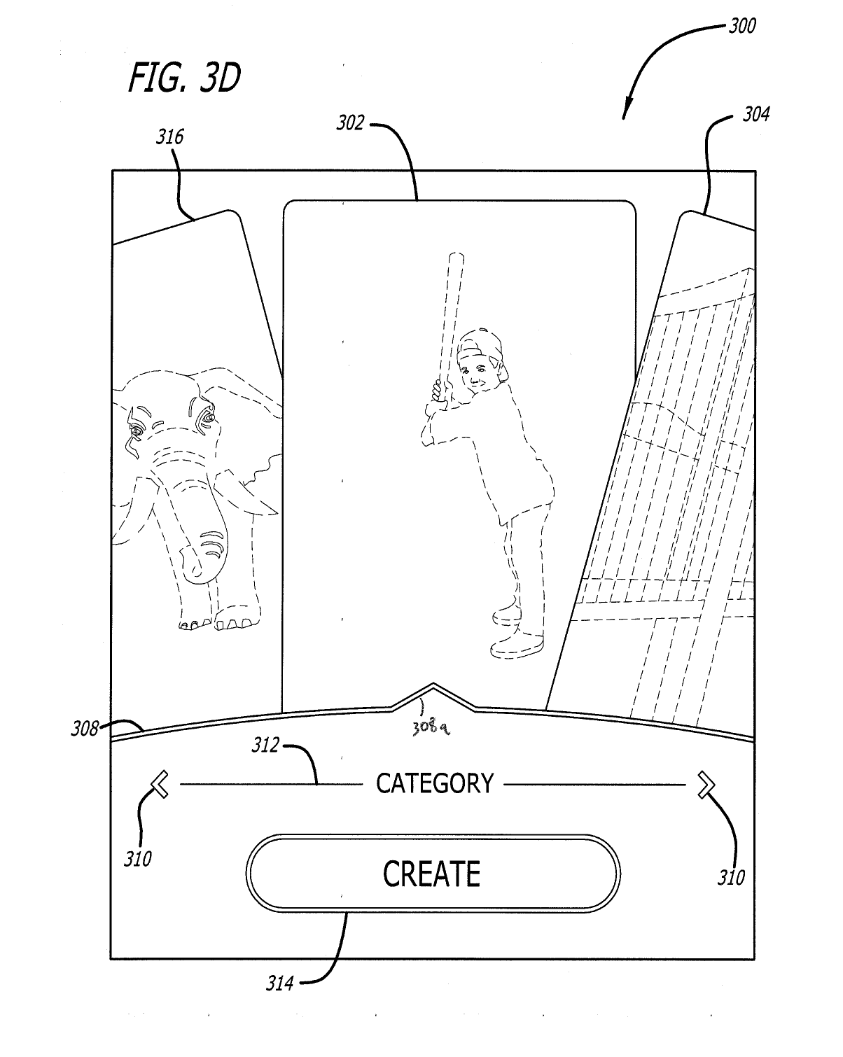

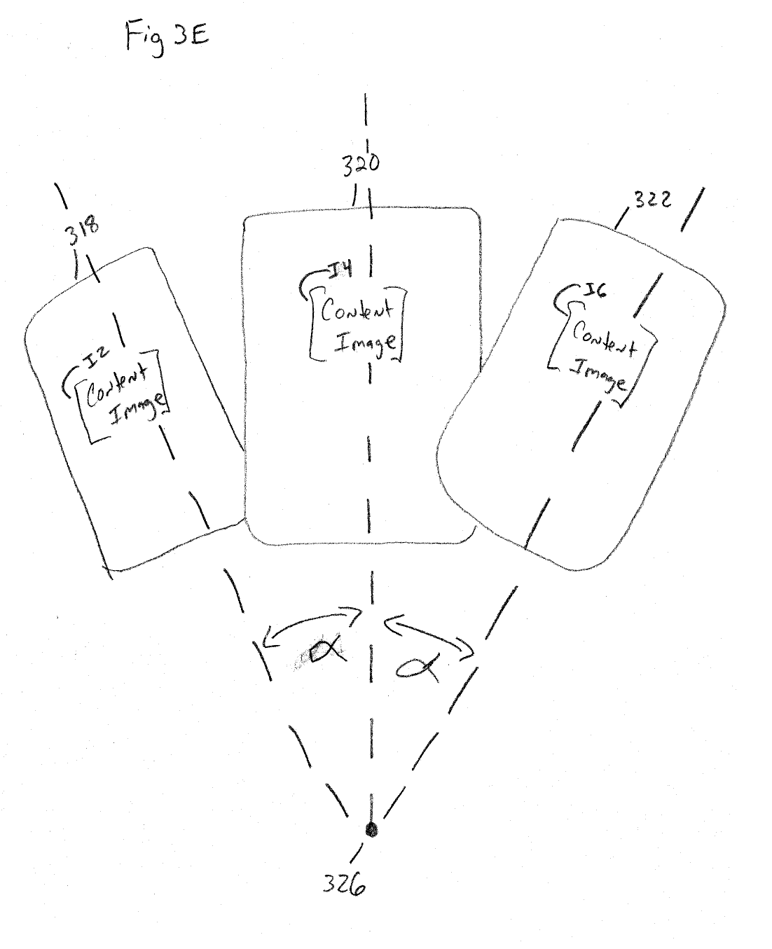

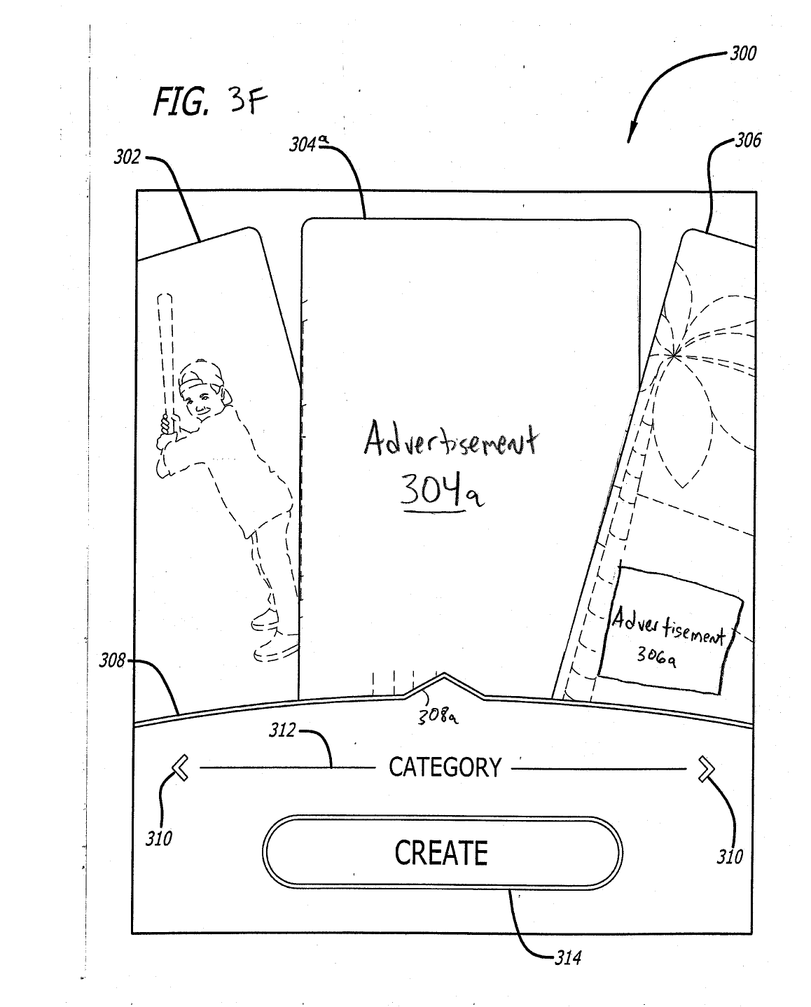

In various embodiments, the presently disclosed system provides a graphical user interface (GUI) presented on a touch device. The GUI, according to some embodiments, can be effectuated by a downloaded application, whereupon executing the application, a content wheel is displayed. In some embodiments, the content wheel includes content “cards” organized radially. In such an embodiment, the display, for example, resembles a fanned out deck of cards held in a radially fanned out configuration. (See, e.g., FIG. 3A.) The content cards are graphical elements visibly displayed on the GUI that act as input elements for selecting or accessing content or functionality represented by each content card. The content cards can depict information that is directed specifically to the user based on the user's expressed desires. For example, content cards can be displayed (or populated with information) as a result of a search, or based upon information provided from a user's profile. Additionally, the content cards can represent information for which the user has expressed a desire to view and interact with, as discussed below in more detail. The content cards can also be programmed, in whole or in part, by a provider of an application that utilizes the radial GUI input elements described herein.

The preferred embodiments of the present disclosure will now be described with reference to FIGS. 1-5. The embodiments of the present disclosure provide for an interactive content wheel. The content wheel enables a user to view and interact with an infinite amount of information. Specifically, the content wheel enables a user to easily cause scrolling on a display screen using a touch device in order to traverse a listing of content or information.

Turning now to the figures, FIG. 1 is a block diagram of an exemplary electronic device 100 (or system) that is coupled to a touch screen interface 102. Touch screen interface 102 can be implemented as part of a larger electronic system, or coupled to electronic device 100 using any suitable technique. For example, touch screen interface 102 can be communicably coupled to electronic device 100 through any type of channel or connection, including serial, parallel, 12C, SPI, PS/2, Universal Serial Bus (USB), Bluetooth, RF, IRDA, or any other type of wired or wireless connection to list several non-limiting examples. Similarly, the various elements of electronic device 100 (e.g. processing components, circuitry, memory, casing materials, physical hardware, and the like) can be implemented as part of an overall system, as part of touch screen interface 102, or as a combination thereof.

The term “electronic device” is used to refer broadly to any type of device that communicates with a “touch screen interface.” As discussed above, the electronic device 100 can thus comprise any type of device or devices in which touch screen interface 102 can be implemented in or coupled to. As non-limiting examples, electronic device 100 can comprise any type of personal computer, portable computer, workstation, tablet, smartphone, personal digital assistant, video game player, communication device, media device, an input device, or a combination thereof. These examples are meant to be representative and broadly construed.

For example, communications devices can include wired phones, wireless phones, and electronic messaging devices; input devices include touch sensors such as touch screens and touch pads, keypads, joysticks and mice, and remote controls; media devices recorders and players include televisions, music recorders and players, and set-top boxes such as cable descramblers and video recorders or players; and combination devices include cell phones with built-in cameras, PDAs that can double as electronic messaging systems or cell phones, and the like. In some embodiments, electronic device 100 can be itself a peripheral to a larger system, and communicates with another device (in addition to the touch screen interface 102) using a suitable wired or wireless technique. Examples of peripherals include a remote control for a television, set-top box, or music system, a terminal on a wired network, and a media device capable of downloading media wireless from a separate source. Accordingly, the various embodiments of electronic device 100 may include any type of processor, memory, display, or other component as appropriate, and the elements of device 100 may communicate via a bus, network, or other wired or wireless interconnection as applicable. Additionally, electronic device 100 can be a host or a slave to touch screen interface 102. The interactions involving one or more users and electronic device 100 can also take place on additional non-touch screen devices such as a mouse cursor and a traditional computer monitor.

To facilitate scrolling, touch screen interface 102 includes a display screen 104 and a touch sensor device 106, both of which are communicably coupled to processor 108. Display screen 104 is any type of electronic display capable of displaying a visual interface to a human user, and can include any type of LED, CRT, LCD, plasma, or other display technology. Touch sensor device 106 is sensitive to some aspect of object motion of one or more input objects 110 such as fingers and styli in its sensing region. For ease of explanation, single fingers are usually used in the explanations and exemplary embodiments described in this document, even though input from alternatives such as individual ones, averaged versions, or combinations of one or more input objects 110 can be sensed to interact with the content wheel function.

It should be noted that the terms “object motion,” and “positional information” are intended to broadly encompass absolute position information, relative position information (reflecting changes in position), and also other types of spatial-domain information such as velocity, acceleration, speed, and the like, including measurement of motion in one or more directions. The resolution of the positional information can comprise a single bit (e.g. ON/OFF) or multiple bits, as appropriate for the application at hand. Various forms of object motion and positional information may also include time history components, as in the case of gesture recognition and the like. Accordingly, touch sensor devices can appropriately detect more than the mere presence or absence of an object and may encompass a broad range of equivalents.

It should also be noted that although the various embodiments described herein refer to “touch sensor devices,” “proximity sensors,” or “touch pads,” these terms as used herein are used synonymously herein, and intended to encompass not only conventional touch sensor devices, but also a broad range of equivalent devices that are capable of detecting positional information about one or more fingers, pointers, styli and/or other objects. Such devices may include, without limitation, touch pads, touch tablets, biometric authentication devices, handwriting or character recognition devices, and the like. Thus, the interactions between one or more users and touch screen interface 102 could include a touch screen interface 102 with a touch sensor device 106 and one or more fingers, styli, other input objects 112, or a combination thereof.

Similarly, “sensing region” as used herein is intended to broadly encompass any space where touch sensor device 106 is able, if in operation, to detect the input object(s). In a conventional embodiment, the sensing region extends from the surface of display screen 104 in one or more directions for a distance into space until signal-to-noise ratios prevent object detection. This distance may be on the order of less than a millimeter, millimeters, centimeters, or more, and may vary significantly with factors such as the type of sensing technology used, design of touch sensor interface, characteristics of the object(s) sensed, the operating conditions, and the accuracy desired. For example, embodiments with resistive technology would usually include sensing regions encompassing the thickness of the sensor electrode stack-up, as physical contact of the electrodes is usually required for proper sensing. As another example, embodiments with capacitive technology would usually include sensing regions extending from the display screen 104 to some distance from the display screen. As yet another example, embodiments using inductive technology would usually include sensing regions extending further into space than capacitive and resistive embodiments. Accordingly, the size, shape, and exact locations of the particular sensing region of touch sensor 106 would likely vary widely from embodiment to embodiment.

The touch sensor device 106 can use a variety of techniques for detecting an input object. As several non-limiting examples, touch sensor device 106 can use capacitive, resistive, inductive, surface acoustic wave, or optical techniques. In a common capacitive implementation of a touch sensor device 106, a voltage is typically applied to create an electric field across a sensing surface. A capacitive version of touch sensor device 106 would then detect the position of an object by detecting changes in capacitance caused by the changes in the electric field due to the object. Likewise, in a common resistive implementation of touch sensor device 106, a flexible top layer and a bottom layer are separated by insulating elements, and a voltage gradient is created across the layers. Pressing the flexible top layer creates electrical contact between the top layer and bottom layer. The resistive version of touch sensor device 106 would then detect the position of the object by detecting the voltage output due to the relative resistances between driving electrodes at the point of contact caused by the object. In an inductive implementation of touch sensor device 106, electrodes pick up loop currents induced by a resonating coil or pair of coils, and use some combination of the magnitude, phase, and/or frequency to determine distance, orientation or position. In all of these cases, touch sensor device 106 detects the presence of an object and delivers positional information to processor 108. Touch sensor device 106 is not limited to a single technology, and can utilize any combination of sensing technology to implement one or more sensing regions.

For example, touch sensor device 106 can use arrays of capacitive sensor electrodes to support any number of sensing regions. This can be achieved by providing, for each sensing region, an appropriate number of conductive sensor electrode(s) adapted to sense capacitively and connecting them to an appropriate number of conductive routing traces. In most cases, a plurality of capacitive sensor electrodes would be coupled to a plurality of routing traces that are equal to, or fewer in number than, the sensor electrodes. In operation, the plurality of conductive traces are coupled to processor 108, and processor 108 is adapted to control touch sensor device 106 by driving the plurality of conductive sensor electrodes electrically using the plurality of conductive routing traces. For example, touch sensor device 106 can use capacitive sensing technology in combination with resistive sensing technology to support the same sensing region or different sensing regions.

Thus, depending on factors such as the sensing technique used for detecting object motion, the size and shape of the sensing region, the desired performance, the expected operating conditions, and the like, touch sensor device 106 and processor 108 can be implemented with a variety of different ways. The sensing technology can also vary in the type of information provided, such as to provide “zero-dimensional” positional information as a binary value (e.g. ON/OFF indicating presence or contact), “one-dimensional” positional information as a scalar (e.g. location, velocity, or speed along a centerline of a sensing region), “two-dimensional” positional information (e.g. location, velocity, or speed indicated with information measured about horizontal and vertical axes, angular and radial axes, or any other combination of axes that span two dimensions), and even higher-dimensional values along more axes (e.g. force) given appropriate sensor design. The type of information provided can also be results derived from the N-dimensional positional data, such as a combination of meaningful values indicative of the N-dimensional positional data, and the like.

In touch screen interface 102 of electronic device 100, processor 108 is coupled to touch sensor device 106 and display screen 104. Generally, processor 108 receives electrical signals from touch sensor device 106, processes the electrical signals, and communicates with display screen 104. As discussed below, the processor 108 is operative to download, install and run application 110 which provides the content wheel. The application 110 is implemented, or executed, by the processor 108 through interactions with the touch sensor device 106. Processor 108 would also typically communicate with electronic device 100, providing indications of input received on touch sensor device 106 and perhaps receiving information or instructions in turn.

Processor 108 can receive electrical signals from touch sensor device 106 in a variety of ways. For example, processor 108 can selectively drive and read individual sensor electrodes of touch sensor device 106 in sequence, subsets of the sensor electrodes with each other, or all of the sensor electrodes simultaneously, and can change the sensor electrodes driven in a predefined or dynamically determined manner. Processor 108 can also perform a variety of processes on the electrical signals received from touch sensor device 106 to implement touch screen interface 102. For example, processor 108 can detect object motion by deriving absolute position, relative motion, velocity, speed, or any other form of positional information appropriate using the signals from the sensor electrode(s). Processor 108 can indicate an appropriate response to the positional information to electronic device 100 or render an appropriate response on display screen 104 directly, depending on how the system is set up. Processor 108 can also generate and provide signals in response to instantaneous or historical information about object motion as appropriate for the application at hand. In addition, processor 108 can report information to electronic device 100 continuously, when a threshold on one or more positional information attributes is passed, or when an identifiable input sequence (e.g. a tap, stroke, swipe character shape, gesture, and the like) has occurred on touch sensor device 106. Similarly, processor 108 can cause display screen 104 to show various visual elements in response to such information.

Processor 108 can also determine when certain types or combinations of object motion occur proximate to touch sensor device 106. For example, processor 108 can distinguish between object motion of a first object combination (e.g., one finger, a relatively small object, and the like) and object motion of a second object combination (e.g., two adjacent fingers, a relatively large object, and the like) proximate a sensing region of touch sensor device 106, and can cause appropriate results in response to that object motion. Additionally, processor 108 can distinguish the temporal relationship between object motion of different object combinations. For example, processor 108 can determine when object motion of the first object combination has followed object motion of the second object combination, and provide a different result responsive to the object motions and their temporal relationship.

In operation, at least part of the sensing region of touch sensor device 106 overlaps a portion of or the entire display screen 104, such that touch screen operation is enabled. For example, the touch screen interface 100 can be adapted such that user input can involve direct mapping of user input on the touch screen interface 100 to positions of a displayed user interface underneath the user input. With touch screen operation enabled, a user can interact with a part of touch screen interface 102 where touch sensor device 106 overlaps display screen 104, and cause a response on touch screen interface 102, electronic device 100, or both. Typically, touch screen operation allows one or more users to interact with different portions of the touch screen interface 100 where touch sensor device 106 overlaps display screen 104, and causes different responses on touch screen interface 102 depending on which type of interaction and which portion of touch screen interface 102 involved. Typically, as user(s) provide input to touch screen interface 102, touch sensor device 106 suitably detects positional information regarding input object(s) in one or more sensing regions and provides this positional information to processor 108. Processor 108 appropriately processes the positional information to accept inputs from the user. In response to the input, processor 108 may cause a response on display screen 104, such as by moving one or more cursors, highlighters, or other items shown on display screen 104, by scrolling through one or more lists or other images shown on display screen 104, by changing one or more characteristics of items shown on display screen 104, and by any other appropriate method.

To facilitate scrolling, processor 108 is adapted to execute application 110 which causes a graphical content wheel to be displayed on the display screen 104. The content wheel is enabled for a user's interaction. The content wheel can also indicate a scrolling path or region for received object motion. For example, the content wheel can provide a user a circular scrolling path for traversing items of content or input elements lending to or representing content. Additionally, the content wheel can be effectuated upon a user interacting with a sensing region configured to recognize inputs respective of the content wheel. For example, the content wheel can spin when a user interacts with the sensing region by inputting a circular swiping object motion. Also, the input can be respective of a horizontal swipe in order to spin the wheel in that direction; however, spinning in a circular manner.

According to some exemplary embodiments, the content wheel user interface is provided by a downloadable application, application 110. For example, application 110 can be downloaded to the electronic device 100 by the user. Application 110 can be downloaded from an “app store”, e.g., an online resource that provides downloadable applications for user devices, or from a hosting web site. For example, users can download or use over-the-air applications or widgets (which are processes or functionality which run within an application, such as a client or server application) from a variety of online application vendors. Other embodiments may exist where the content wheel is provided by or as part of the electronic device 100, local or web-based application software, or operating system running on or provided with the electronic device 100.

The content wheel, a by-product of execution of the application 110 by the processor 108, or via a browser displaying a web-based content wheel user interface or any other application that can detect or receive or utilize scroll commands to control a user interface, selectively, such as in response to touch sensor device 106 sensing object motion that corresponds to a recognized scrolling gesture, enables scrolling on a display screen 104. A scrolling gesture is an input by the user with the touch screen, e.g., a tap, stroke, swipe, character shape, gesture, and the like. For purposes of this disclosure, and object motion and scrolling gesture are synonymously used herein, and are intended to encompass not only conventional user inputs related to traditional computing devices, but also inputs respective of touch sensor devices, including, but not limited to one or more fingers, pointers, styli and/or other objects. Application 110 therefore allows display screen 104 to provide a versatile graphical user interface (GUI). Touch screen interface 102 also enables electronic device 100 to allow the user to scroll in an intuitive manner, even as it reduces the chances of accidental scrolling.

The features and functionality of the content wheel provided by the application 110 are discussed herein. Many different embodiments exist that fall within the implementation contemplated for the content wheel. Application 110 recognizes (i.e. identifies) one or more specific types of object motion as corresponding to gesture(s) for scrolling. In an example, object motion substantially following at least a portion of a substantially circular path or region corresponds to the scrolling gesture. Also, object motion substantially following at least a portion of a horizontal path corresponds to a scrolling gesture for which the content wheel is configured to respond.

As depicted in FIGS. 3A-3D, and according to some embodiments, the content wheel is responsive to an object motion along the scrolling path or region. In a non-limiting example, application 110 identifies a direction of the object motion input by the user and causes scrolling in a way corresponding to the direction of the object motion. In some exemplary embodiments, the content wheel spins in circular motion corresponding to the direction of input provided by the user. For example, a user swipes the content cards situated and displayed on the content wheel in a left to right manner. Thus, the content wheel will spin to the right. The scrolling path or region, in some embodiments, can be a direction along a horizontal axis. Embodiments exist where the scrolling path or region for which the content wheel is responsive can also be along the y-axis, z-axis, circular (clockwise or counter-clockwise), or any combination thereof.

In some embodiments, application 110 causes scrolling in particular ways. In other non-limiting examples, a clockwise direction of the object motion can correspond to rightwards scrolling, and a counter-clockwise direction of the object motion can correspond to leftwards scrolling. For example, the content wheel depicted in FIGS. 3A-3D, responds to a horizontal scrolling motion. That is, as the user, for example, inputs an object motion from left to right, or right to left, or even in a circular manner, the content wheel responds to the input and scrolls the content cards associated with the content wheel in the same direction of the input object motion. Alternatively, the direction of the spin of the content wheel can be counter to the user's input object motion. This can be based upon device or user settings or configurations. The speed and length of the scroll are based upon the speed, acceleration, velocity, or any combination thereof, of the scroll.

Application 110 can also cause the graphical content wheel to appear in a certain way. In one example, application 110 can change a characteristic of the graphical content wheel in response to a change in a speed of the object motion along the scrolling path or region. Among various non-limiting implementations, characteristics that can be altered are as follows: the size of the content wheel, the transparency of the content wheel, speed of the content wheel's spin or scrolling, or a combination thereof. In another example, application 110 can make a portion or the entirety of a scrollable list of items viewable through the graphical content wheel.

As depicted in FIGS. 3A-3E, application 110 can cause display screen 104 to show particular interface element(s), referred to as content cards. In one example, a visual indicator can be incorporated in or caused to appear on the display screen proximate to the graphical content wheel. For example, indicators can be provided on the content wheel (on the arc 308 or within the content cards themselves, or even on the connecting line 312 between the arrows 310, as discussed below). The indicators can provide information about the current position of scrolling or a current direction of scrolling. Alternatively or additionally, the visual indicator can be a change in appearance, location or dimension of the content card itself or may be auditory. In exemplary embodiments, the display screen 104 shows a list of content items, referred to as content cards, situated around the content wheel. As illustrated in FIGS. 3A-3D, there can be three displayed content cards; thus, as the content wheel is subject to scrolling gestures by the user, the content cards will appear to spin in a circular manner as if rotating around an axis of rotation 326 perpendicular to the plane of the user interface, and other/additional content cards can be displayed.

As illustrated in FIG. 3E, and according to some exemplary embodiments, each content card 318, 320, 322 is displayed on the content wheel at a static angle α to each other content card. That is, each card is displayed at a angle α with respect to the immediately adjacent displayed content card(s). As depicted in FIG. 3E, content card 318 is displayed at angle α to content card 320, and content card 320 is displayed at angle α to content card 322. Similar to FIGS. 3A-3D, content cards 318, 320, 322 display content respective of additional information retrievable through interaction with a respective content card. Thus, content cards 318, 320 and 322 can display card content 12, 14 and 16, respectively. Each displayed content card 318-322 is displayed as being positional relative to a virtual axis of rotation 326. Thus, based upon the axis of rotation 326, angular rotation, angular velocity and angular acceleration can be determined and utilized in determining the virtual rotation of the content cards.

In an exemplary embodiment, the angle α is 15 degrees. In some embodiments, the angle α of display can be varied based upon characteristics of the display (e.g., size and display ratio of the touch screen device), or according to predetermined characteristics set by the user or application provider. The content wheel can comprise any number of cards at any respective angle. That is, as each new “card” comes into view, as discussed above in relation to FIGS. 3B-3D, it can be programmed to display a different content image so that the perceived number of “cards” on the virtual wheel can exceed the number of cards that could be fit on an actual physical wheel of similar dimension. Therefore, there can essentially be any number of cards on the content wheel. However, according to exemplary embodiments, only three (3) are visible at a time. Embodiments exist where the number content cards displayed can be varied based upon characteristics of the display (e.g., size and display ratio of the touch screen device), or according to predetermined characteristics set by the user. Thus, as the content wheel is “spun”, based upon input by the user, the displayed content cards are programmatically changed, thereby allowing the other content cards associated with the content wheel to be displayed.

As the wheel is spun resultant of, for example, a user's swiping motion 318, the user input elements or cards are rendered in a manner that visually creates the impression that the user interface elements or cards are rotating along a circumferential path 324 in a manner similar to a “wheel of fortune.” The circumferential path is represented by the arc 308 in FIGS. 3A-3D. In some embodiments during the spin, the content cards can appear to be displayed on the content wheel at an adjusted angle adjusted from the static angle α when the cards are stationary. In an exemplary embodiment, during the spin, the content cards angular display with respect to an adjacent card is 7.5 degrees. In some embodiments, the spinning of the content wheel can provide an animation indicating scrolling of the content wheel. However, other embodiments exist where the state of cards, and angle in which they are depicted during a spin can be varied based upon characteristics of the display (e.g., size and display ratio of the touch screen device), or according to predetermined characteristics or configurations set by the user or application provider. It should be understood that the depiction of the content cards can take any shape, such as regular or irregular circles, ovals, squares, triangles, and the like, either set by the user, based upon the type and/or scope of information the cards are representing, application choice or set in accordance with the type of device rendering the content wheel or content card's display

The graphical user interface can be further enhanced with additional functionality provided by application 110. In an example, display screen 104 is responsive to a selection of a content card along the graphical content wheel, as discussed in more detail below. Thus, when a user taps or selects a particular card they can then be directed to context or application resources related to the context information depicted in the interface element. The navigation task can be effectuated by input respective of a content card(s) 302, 304, 306, 316, arrow(s) 310 or button 314, as discussed below in FIGS. 3A-3D.

The content wheel can also be used with user configurable interfaces such that the graphical content wheel is user configurable. In some embodiments, user(s) of the application 110 can define and change any or all aspects of the content wheel function, and this can be accomplished through direct user input, analysis of past user history, or a user or other users' profiles, or a combination thereof. To note just a few examples, users can set and change one or more of the following: characteristics of scroll gesture(s); content wheel size, transparency, or visual appearance; scroll amount, speed, or ballistics; durations associated with the appearance and disappearance of the content wheel; timings associated with content wheel response; if precursor images are used and their characteristics if so; what is scrolled; or any other aspect of the content wheel function.

As discussed above, many technologies are available to implement the touch sensor device 106. In one likely embodiment, touch sensor 106 is stacked with display screen 104 and senses capacitively. Thus, via application 110, and the content wheel depicted on the touch screen interface 102, provide a more versatile graphical user interface (GUI) that enables the user to scroll in an intuitive manner without requiring the user to perform a more complex gesture on the proximity sensor device, such as repeatedly lifting and retouching a finger to the sensing region.

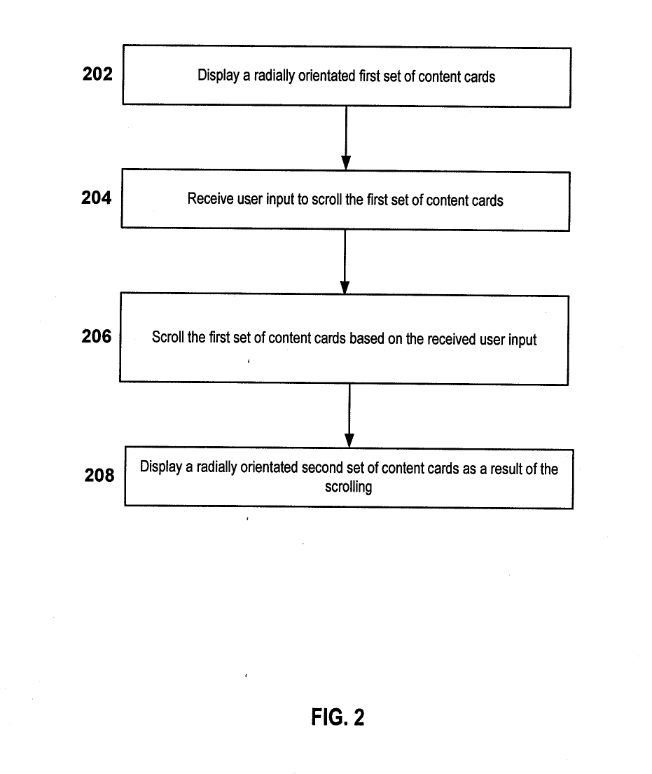

Turning now to FIG. 2, a flow chart of a touch screen process 200 is shown. Touch screen process 200 can be used with the electronic device 100 shown in FIG. 1, 4 or 5, or any electronic systems or touch screen interfaces described herein. Touch screen process 200 illustrates the content wheel functionality provided by application 110.

In step 202, a plurality of content cards are visibly displayed on the graphical user interface along a virtual content wheel. As discussed above, content cards are preferably graphical elements visibly displayed on the GUI that act as input elements for selecting or accessing content or functionality represented by each content card. The content cards preferably depict information that is directed specifically to the user based on the user's expressed desires.

In step 204, the electronic device receives a user input to scroll the content cards. That is, application 110 determines if the sensed object motion corresponds to a scrolling gesture recognizable and actionable by the content wheel. The sensed object motion is detected by the applicable touch sensor device of the touch screen interface (e.g. touch sensor device 106 of touch screen interface 102) during operation, which means that the sensed object motion takes place proximate to the touch sensor device. As described above, the sensed object motion can comprise any type of positional information of any number and type(s) of objects or inputs, and be sensed using any technology appropriate for the touch sensor device 106.

In an exemplary embodiment, the touch sensor device 106 uses capacitive, inductive, or resistive technology to sense object motion of a single finger, stylus, or another input object 112, and provides electric signals to the processor (e.g. processor 108). The processor then examines the electric signals from touch sensor device to compute absolute position or relative motion about the input object. As one example, sensing object motion proximate to the touch screen comprises sensing the position of an object over time and then calculating how the object has moved from the data gathered on object positions over some amount of time. The relevant display screen 104 oftentimes would already be displaying part or all of a set of scrollable items on the touch screen when the object motion is sensed, or the display screen may change to show part or all of a set of scrollable items in response to the sensed object motion or some other event.

According to some embodiments, the content wheel is responsive to an object motion along the scrolling path or within the scroll region. The object can be a finger, styli, or other type of input 112 utilized on a touch device. Thus, application 110 identifies a direction of the object motion input by the user and causes scrolling in a way corresponding to the direction of the object motion. In some exemplary embodiments, the content wheel spins in circular motion corresponding to the direction of input provided by the user. For example, a user swipes the content cards situated and displayed on the content wheel in a left to right manner. Thus, the content wheel will spin to the right. The scrolling path or region, in some embodiments, can be either direction along a horizontal axis. Embodiments exist where the scrolling path or region for which the content wheel is responsive can also be along the y-axis, z-axis, circular, or any combination thereof.

Embodiments of sensed object motions (or scrolling gestures) can include, but are not limited to, horizontal gestures, vertical gestures and/or circular gestures. It should be understood that the content wheel can be adapted to be responsive to any type of user input (or object motion). In step 206, upon receiving the user input (swipe motion), the content wheel spins according to the direction, and in some embodiments according to the received speed, velocity and/or acceleration of the received (or identified) object motion.

In some exemplary embodiments, scrolling results in changing what is shown on a visual display (e.g. on display screen 104). In general, scrolling allows users to navigate through larger sets of data. Scrolling can allow a user to navigate through an array (or listing) of data to select a particular content card or interface element. This type of scrolling would appear to users as if they were moving highlighters, selection points, or other indicators through whatever portions sets of scrollable items are displayed. Thus, it would appear to users as if they were spinning a wheel in order to view other displayed content not currently displayed. Thus, as in step 208, as a result of the scrolling (or spinning of the virtual wheel) different content cards, or portions of the wheel can be brought into view. In some embodiments, the scrolling occurs simultaneous (or as close to real-time) to the user's input. In alternative embodiments, the scrolling result need not appear simultaneously with the determination, or appear at an exact time after the determination. However, scrolling can also occur reasonably soon after determination, even as soon as possible, to provide proper feedback to user(s).

Many different embodiments fall within the implementation contemplated for touch screen process 200. For example, causing the set of scrollable items to scroll can involve the steps of determining a direction of the object motion and causing scrolling in a way corresponding to the direction of the object motion. Determining a direction can involve ascertaining if the motion is clockwise or counterclockwise, up or down, left or right, or any other combination that fits the scrolling function enabled by the content wheel (e.g. similar or not similar to a direction along the path indicated by the graphical content wheel, and coupled with clearly along, slightly deviating, or clearly deviating from the path). In some embodiments, a clockwise direction of the object motion corresponds to scrolling in a rightwards direction, while a counterclockwise direction corresponds to scrolling in a leftwards direction, or vice versa.

Alternative embodiments also exist relating to a mobile device. For example, should a user tilt the device at a predetermined angle, or shake the device with a predetermined force, so as to register an ascertainable direction and input, application 110 will recognize this as user input and scroll the wheel. The scroll of the wheel, that is the direction and speed or length of the scroll, will be based upon the angle of the tilt and/or force of such shaking of the device. Such implementations will be discussed in more detail below.

FIGS. 3A-3E provide an example of a graphical user interface displaying the content wheel in accordance with some embodiments of the present disclosure. FIGS. 3A-3D detail one embodiment of the content wheel, and how the content wheel is implemented by a user. Embodiments of the present disclosure involve presenting a content wheel in order to present scrollable and actionable content to a user on a computing device.

An example regarding populating the content wheel's content cards involves a user accessing a travel web service via the Internet, for example, using their respective mobile device. A user can search for specific destinations, or destinations can be selected in accordance with a user's expressed interests or past travel history, which can be identified from a user's profile. The user's profile can be affiliated or associated with the application 110, a third party provider and/or from a cloud based service.

Through the application 110, specific destinations can be represented by different content cards. That is, a user can request travel itineraries to different destinations. For example, a user can be presented with itineraries for a trip to Boston to watch a baseball game, a trip to San Francisco and a trip to Key West. Therefore, displayed along the content wheel will be content cards depicting each itinerary 302, 304, 306, respectively, as discussed below. It should be understood that other itineraries can also be associated with the content wheel. Thus, as discussed in more detail below, the user can swipe the content wheel and view the other itineraries. For example, besides the Boston, San Francisco and Key West itineraries, at least one other itinerary can be situated on the content wheel, for example, a trip to the San Diego Zoo. Upon selection of or interaction with the San Diego Zoo content card or interface element, the user will be directed to or linked to or will have displayed further functionality or program resources relevant to or related to the San Diego Zoo. Therefore, upon the user swiping the content wheel, at least one of the itineraries currently being displayed prior to the swipe will be removed, and the San Diego Zoo itinerary 316 will be displayed. As should be understood, the actions for generating the itineraries, the itineraries represented by the content cards on the content wheel and actions taken upon each content card can be saved to a user's profile associated with application 110, or saved with a third party provider and/or the cloud. Cloud storage can be affiliated with the user's use of the application 110, or can be affiliated with a separate user account. Also, the actions for generating the itineraries, the itineraries, and actions taken upon each content card can be stored locally on the user's device.

As discussed above, a GUI 300 is presented on a touch device. As shown in FIG. 3A, the GUI 300 provides a content wheel display that includes content cards 302, 304, 306 in an arc 308 along a circle. In an embodiment, the content wheel's circular impression is supported by the arc 308. The content cards virtually situated along the virtual circumference of the content wheel which are not currently viewable are easily able to be brought into view by a scroll or spin of the content wheel.

The content wheel is populated by content cards 302, 304, 306 being displayed along the arc 308 so that the content cards are presented at a respective angle α to each adjacent content card. As discussed in FIG. 3E, the angle α, according to some exemplary embodiments, is a 15 degree angle. In some embodiments, the angle of display of the content cards 302, 304, 306 can be varied based upon characteristics of the display (e.g., size and display ratio of the touch screen device), or according to predetermined characteristics set by the user. In some embodiments, the content wheel does not need to be perfectly round, and could adopt a variety of shapes; for example, the content wheel could be elliptical instead of circular in shape to accommodate screens with different aspect ratios. Thus, this could be reflected by the shape of the arc 308.

The content cards 302, 304, 306 are graphical elements visibly displayed on the GUI 300 that provide information to the user. The content cards 302, 304, 306 can depict information that is directed specifically to the user based on the user's expressed desires. According to some exemplary embodiments, each content card 302, 304, 306 can depict different content. That is, content card 302 depicts different content from content card 304, and both depict different content from content card 306. Each content card can provide content in any electronic form, including, but not limited to, images, text, video, and audio. Also, the content within each content card can be a product of a user search. Thus, the content cards can display one or more search results. Thus, from the above example, content card 302 represents the trip to Boston, content card 304 is for the trip to San Francisco, and content card 306 is for the trip to Key West. Each of these content cards is actionable. That is, a user can select a card, via a tap or other recognized input on a touch screen. Upon receiving the selection, the application 110 can provide the user with other information relating to the content card. For example, regarding content card 302 for the trip to Boston, the subsequent screen can provide a user with information regarding directions to Boston from their current location, places to stay, places to eat or drink, and places to buy tickets for the baseball game within the itinerary.

Other embodiments and examples exist where the content cards can be representative of any type of content or information that a user wishes to view. For example, the content cards can provide the user with the ability to search the internet based upon the represented content within the content card. For example, a content card 302 for the trip to Boston for a baseball game may provide the user with a search based on the term “Boston”, and/or “Fenway Park”, the baseball stadium in Boston. Other embodiments respective to actionable graphically displayed items should be understood to apply to the content cards 302, 304, 306 and the content wheel's features.

In various embodiments, the virtual number of content cards can comprise any number of cards, since each content card can be re-painted or re-populated with different content image or text data prior to it becoming visible by rendering on the display. That is, there can essentially be any number of cards virtually situated along the content wheel. According to exemplary embodiments, three (3) content cards 302, 304, 306 are visible at a time. Alternative embodiments exist where the number content cards 302, 304, 306 displayed can be varied based upon characteristics of the display (e.g., size and display ratio of the touch screen device), or according to predetermined characteristics set by the user. Thus, as the content wheel is spun, based upon input by the user, the displayed content cards are programmatically changed, thereby allowing the other content cards associated with the content wheel to be displayed. Additionally, during the spin, the content cards can be spun in a manner that provides an animation indicating no only the length or time-span of the spin, but also the direction of the spin. Such animation would indicate the scope of the scrolling of the listed content affiliated with the content wheel. It should be understood that the depiction of the content cards can take any shape, either set by the user, based upon the type and/or scope of information the cards are representing, or set by the type of device rendering the content card's display. Also, the content wheel can be combined with other input controls, regardless of if these input controls are implemented with the touch screen or not.

As depicted in FIGS. 3A-3D, arrows 310 are touch sensitive navigation controls. These arrows 310 are actionable controls that provide the user the ability to spin the content wheel and alter the content cards displayed. For example, a user can tap on the right arrow 310 which would spin the wheel to the right, and vice versa for the left arrow 310. The user may also be able to hold down on one of the arrows which would cause a constant and seamless scroll of the content cards associated with the content wheel until the user releases such arrow 310, or duration may affect the speed of the rotation. Connecting the arrows 310 is a line 312. The line 312 can provide a textual indication regarding the category of information provided by the content cards. The line 312 can also provide an indication or information relative to the current position of scrolling within the content wheel or a current direction of scrolling.

Button 314 provides input control via a configurable button. Button 314 enables a user to select a content card for further action, as discussed above. In exemplary embodiments, the content card situated in the center of the arc 308, content card 304 in FIG. 3A, is actionable. This is signified by the pseudo-arrow formation 308a centered upon the arc 308. Therefore, instead of a user tapping, or depressing on the screen respective of content card 304, a user is afforded the ability to depress or provide input via button 314. In some embodiments, button 314 can be a search entry area. That is, a user can perform a search by entering text, or any other recognizable data into the search area to effectuate search results being displayed on the content wheel. As discussed above, each content card can display one or more search results. In some embodiments, the search entry area can be displayed anywhere on the GUI (not shown).

As discussed above, and illustrated in FIGS. 3A-3D, the content wheel spins in accordance with user input (e.g., object motion or scrolling gesture). For sake of discussion, the user's input is a finger swipe 318 of the content wheel. As illustrated in FIG. 3A, content cards 302, 304 and 306 are displayed on the arc 308 within the GUI 300. The content cards 302, 304 and 306 are displayed, in accordance with an exemplary embodiment, at a 15 degree angle. According to some embodiments, and as illustrated in FIGS. 3A-3D, when displayed, the content card situated to the right of the another content card will partially overlay the content card to its immediate left. This creates a “fan” effect which provides an aesthetically pleasing experience to the user. Also, this may signify the preferred direction for scrolling. Embodiments can also exist where there is no overlay of the content cards, or the content cards to the left of another can overlay the card immediately to its right, and other various combinations thereof. Also, while in certain examples, the shape of the content cards are depicted as rectangles with rounded corners, the content cards can be displayed with squared corners or may be squares or other polygonal shapes or trapezoidal shapes, or the like, with rounded or angled corners or combinations thereof. The cards may also be displayed as regular or irregular circles or ovals or triangles, or the like.

FIG. 3B illustrates that content cards 302, 304 and 306 are actionable by a user's input 318, a finger interaction with the touch screen of the device. Further, as discussed above, arrows 310 and button 314 are actionable. Embodiments may also exist where the user can slide his/her finger 318 along the arc 308 (or in some embodiments, the line 312) so as to scroll along, or spin, the content wheel.

FIG. 3C illustrates the scroll/spin of the content wheel. That is, in response to a user's swipe of the screen 318 (or input respective of arrows 310) the content wheel spins. The spin of the wheel can depend on the speed, velocity or acceleration of the user's swipe (input) 318. In some embodiments, upon a user's swipe, the content cards will move one spot in the direction the swipe occurred, as seen in FIG. 3D. Embodiments can also exist where a swipe of the touch screen can effectuate a randomized spin of the wheel. That is, the spin can be for a random length ranging from one spot to at least one or more revolutions.

As illustrated in FIGS. 3B-3C, a user swiped 318 the touch screen from left to right, therefore, the content cards moved to the right one position. However, given that the content wheel can constitute any number of content cards, the speed, velocity and acceleration of a user's swipe can be taken in account in determining the amount of spin of the content wheel. As discussed below, during the spin, the respective angle α between each immediately adjacent displayed content card can be adjusted to a 7.5 degree angle, as seen in FIG. 3C. Embodiments can exist where the value of a during a spin can be varied based upon characteristics of the display (e.g., size and display ratio of the touch screen device), or according to predetermined configurations set by the user.

From the above example, the content cards represent travel itineraries, or destinations. There are seemingly an infinite amount of destinations a user can travel to, ranging from a local restaurant, to top tourist attractions. Thus, application 110 can account for the speed, velocity and acceleration of a user's swipe. Embodiments also exist where the actual distance, or length, of the swipe registered on the touch screen can effectuate a longer spin of the wheel. For example, a quarter swipe of the touch screen can effectuate a spin of the wheel of only one content card at time. However, a full swipe, from one side of the GUI 300 to the other side of the GUI, can constitute a scroll of more than one content cards. The amount of spin of the wheel in view of length of the swipe, speed, velocity and acceleration can be based upon presets by the user, or predetermined configurations built-in to the application 110.

FIG. 3D illustrates an example of the content cards depicted after a swipe. For example, the content cards previously displayed, content cards 302, 304 and 306, have moved one position to the right. That is, the cards have spun to the right in response to a user's input 318 upon the touch screen, either via a swipe or input respective of the right arrow 310, in the right direction (or clockwise). Thus, content card 306 has moved to the right on position along the content wheel and is no longer displayed. Content cards 316, 302 and 304 are displayed along the arc 308 respectively. As the content wheel comes to a stop, the content cards can be locked into place. This can be implemented so as to thwart any unintended scrolling from unwarranted tilting or shaking of a device.

In some alternative embodiments, as discussed above, the wheel can be scrolled via tilting or shaking the device provided it is configured with acceleration and/or position and/or velocity sensors known in the art or later to become known. For example, should a user tilt the device at a predetermined angle, or shake the device with a predetermined force, so as to register an ascertainable direction, application 110 will recognize this motion and scroll the wheel. The scroll of the wheel, that is the direction and speed or length of the scroll can be based upon the angle and/or force of such shaking of the device. Therefore, up to a predesigned, or user preset threshold, tilting or shaking of a device will not effectuate a scroll of the content wheel. However, meeting and/or exceeding the threshold respective of a tilt or shake can effectuate a scroll should the application preferences be set a certain way, or a user preference enable such features. For example, the threshold for a tilt can be set at a 90 degree angle. Therefore, upon the user holding his/her device at an angle meeting or exceeding a 90 degrees, the wheel will scroll in the direction of the angle tilt. As discussed above, the wheel can rotate to display one new content card, or rotate continuously until the 90 degree tilt is broken. The same is for the shake. A shake of the device can effectuate a single card spin, or vigorous or multiple shakes can cause a continuous spin. The tilt and shake spin features will follow the spin features for swipe of the touch screen.

In FIG. 3D, content card 316 was the content card situated immediately to the left and along side content card 302 prior to the swipe. Content card 316, prior to the swipe, was out of display range, from FIGS. 3A-3B. However, upon receiving the swipe 318 (FIGS. 3B-3C), which instructed the application 110 to spin the wheel one position to the right, content card 316 was brought into view and content card 306 was moved out of view. However, it should be understood that content card 306 can be brought back into view upon an input instructing the content wheel spin left. Also, content card 306 can be brought back into view by continuing to spin the wheel to the right until the content card 306 has made a full revolution around the content wheel.

As illustrated in FIG. 3D, and taking from the above example regarding itineraries, content card 316 represents the trip to the San Diego Zoo, and content card 302 situated to its immediate right and centered on the arc 308 represents a trip to Boston, and content card 304 represents a trip to San Francisco.

The content cards associated with the arc 308 of the content wheel, as well as a user's inputs may be used for advertising purposes, or other various monetization techniques. That is, various monetization techniques or models may be used in connection with sponsored search or content related advertising, including advertising associated with user search queries (content associated with the content cards and how that are implemented or interacted with by a user), or non-sponsored search advertising, including graphical or display advertising. As illustrated in FIG. 3F, a discount coupon or advertisement can be depicted proximate, next to, or within a content card. In accordance with the above example, a discount coupon for a restaurant in Boston can be displayed next to the Boston content card 302 as interface element 304a. Thus, the content card 304 for the San Francisco trip is replaced with an advertisement related to content card 302. In another example, an advertisement 306a for a local Key West restaurant can be displayed within the content card 306 for the trip to Key West.

In an auction-type online advertising marketplace, advertisers may bid in connection with placement of advertisements to be depicted in or more context cards. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals, advertisements may be displayed on web pages resulting from a user-defined search based at least in part upon one or more search terms, or content associated with the content cards. As discussed herein, advertisements may also be displayed on GUIs in association with content displayed on the GUI (or content wheel) or user's interactions therewith.

Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites and by tracking a user's interactions with a GUI, and compiling a profile based at least in part on pages or advertisements ultimately delivered. A correlation may be identified, such as for user purchases or site visits, for example. An identified correlation may be used to target potential purchasers by targeting content or advertisements to particular users. Yet another approach to ad targeting could be based upon a user's current activity. Tracking of a user's path, or current location within a web site, or network of sites, or by tracking a user's interactions with the GUI, and compiling of information associated with the user and/or the user's activity, or location. For example, regarding a user's activity, besides tracking which sites a user is viewing, information related to a user's activity within a site, e.g., their conversations with other users via the provided IM, provide advertisers with real-time topic points that warrant productive pivot points to provide real-time and relevant ads.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of content presented to users or the content being provided by the users on particular sites or via their interaction within a site/domain or network. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

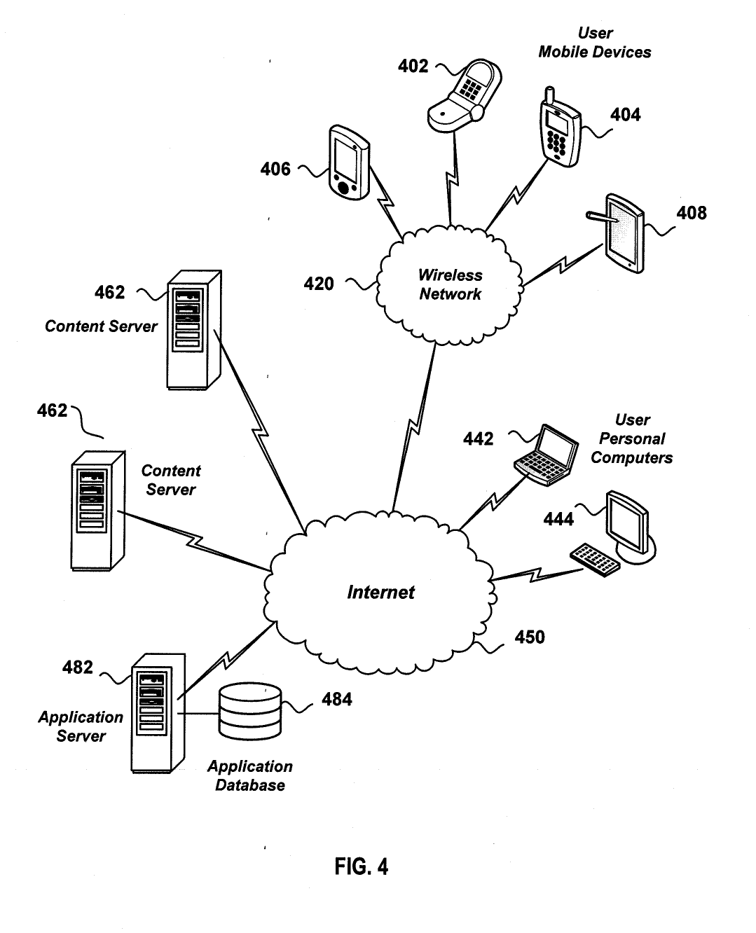

FIG. 4 is a schematic diagram illustrating an example embodiment of a network within which the systems and methods disclosed herein could be implemented. Other embodiments that may vary, for example, in terms of arrangement or in terms of type of components, are also intended to be included within claimed subject matter.

As shown, FIG. 4, for example, includes a variety of networks, such as a wide area network (WAN) such as the Internet 450 and wireless network 420. FIG. 4 additionally includes a variety electronic devices (or user devices), such as user personal computers 442 and 444 and user mobile devices, such as cell phones 402, smart phones 404, PDAs 406 and tablet computers 408. FIG. 4 additionally includes a variety of servers, such as content servers 462 and application (or “App”) servers 482. Embodiments of the network of FIG. 4 can also include one or more ad servers.

The content servers 462 may include a device that includes a configuration to provide content via a network to another device. A content server may, for example, host a site, such as a travel site or social networking site, or a personal user site (such as a blog, vlog, online dating site, and the like). A content server may also host a variety of other sites, including, but not limited to business sites, educational sites, dictionary sites, encyclopedia sites, wikis, financial sites, government sites, and the like.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, and the like.

As discussed above, user devices (or electronic devices) 402, 404, 406, 408, 442 and 444 may include or may execute a variety of operating systems, including a personal computer operating system, or a mobile operating system. A user device 402, 404, 406, 408, 442 and 444 may include or may execute a variety of possible applications such as a client software application enabling communication with other devices, such as communicating one or more messages, such as via email, short message service (SMS), or multimedia message service (MMS), including via a network, such as a social network or photo sharing services.

In various embodiments, user mobile devices 402, 404, 406, 408 interface with one or more wireless networks 420. A wireless network 420 may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless 420 network may further employ a plurality of network access technologies, including Long Term Evolution (LTE), WLAN, Wireless Router (WR) mesh, or 2nd, 3rd or 4th generation (2G, 3G, or 4G) cellular technology, or the like. Network access technologies may enable wide area coverage for devices, such as client devices with varying degrees of mobility, for example.

For example, a network 420 may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like. In various embodiments, user mobile devices 402, 404, 406, 408 may additionally interface with one or more GPS services 430 for real-time positioning information.

Servers 462 and 482 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by the content servers 462, which may include in a non-limiting example, mapping services servers, photo-sharing services servers, and travel services servers, via the Internet 450 using their various devices 402, 404, 406, 408, 442 and 444. For example, among other activities users may engage in via the Internet, a user can access travel services websites and web services hosted by the travel services servers to rate points of interest or to request travel itineraries. In some embodiments, applications, such as application 110, can be hosted by the App server 482. Thus, the App server can store various types of applications and application related information including user profile information in an application DBs 484, which is associated with the App server 482.

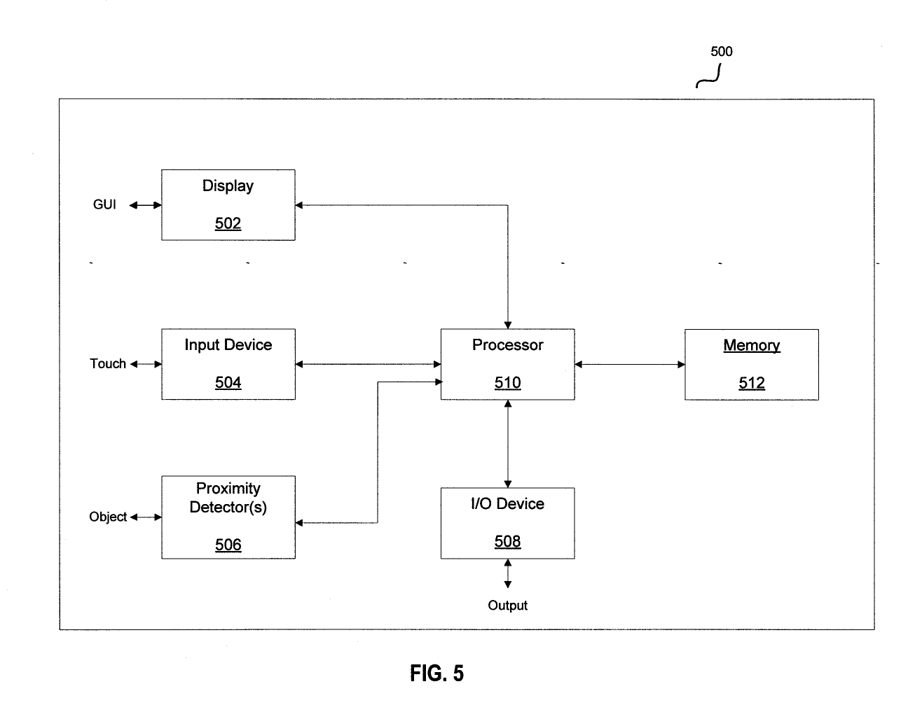

FIG. 5 is a block diagram of an exemplary computer system 500, in accordance with one embodiment of the present invention. The computer system 500 may correspond to a personal computer, such as a desktop, laptop, tablet or handheld computer. The computer system may also correspond to other types of computing devices such as a cellular phones, PDAs, media players, consumer electronic devices, and/or the like.

The exemplary computer system 500 shown in FIG. 5 includes a processor 510 configured to execute instructions and to carry out operations associated with the computer system 500. For example, using instructions retrieved from memory or application 110, the processor 510 may control the reception and manipulation of input and output data between components of the computing system 500. The processor 510 can be implemented on a single-chip, multiple chips or multiple electrical components. For example, various architectures can be used for the processor 510, including dedicated or embedded processor, single purpose processor, controller, ASIC, and so forth.

In various embodiments, the processor 510 together with an operating system operates to execute computer code and produce and use data. By way of example, the operating system may correspond to Mac OS, OS/2, DOS, Unix, Linux, Palm OS, and the like. The operating system can also be a special purpose operating system, such as may be used for limited purpose appliance-type computing devices. The operating system, other computer code and data may reside within a memory block 512 that is operatively coupled to the processor 656. Memory block 512 generally provides a place to store computer code and data that are used by the computer system 500. By way of example, the memory block 512 may include Read-Only Memory (ROM), Random-Access Memory (RAM), hard disk drive and/or the like. The information could also reside on a removable storage medium and loaded or installed onto the computer system 650 when needed. Removable storage media include, for example, CD-ROM, PC-CARD, memory card, floppy disk, magnetic tape, and a network component.

The computer system 500 also includes a display device 502 that is operatively coupled to the processor 510. The display device 502 may be a liquid crystal display (LCD) (e.g., active matrix, passive matrix and the like). Alternatively, the display device 502 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks or OLEDs.

The display device 502 is generally configured to display a graphical user interface (GUI) that provides an easy to use interface between a user of the computer system and the operating system or application running thereon. Generally, the GUI represents, programs, files and operational options with graphical images. The graphical images may include windows, fields, dialog boxes, menus, icons, buttons, cursors, scroll bars, and the like. Such images may be arranged in predefined layouts, or may be created dynamically to serve the specific actions being taken by a user. During operation, the user can select and activate various graphical images in order to initiate functions and tasks associated therewith. By way of example, a user may select a button that opens, closes, minimizes, or maximizes a window, or an icon that launches a particular program. The GUI can additionally or alternatively display information, such as non-interactive text and graphics, for the user on the display device 502.

The computer system 500 also includes an input device 504 that is operatively coupled to the processor 510. The input device 504 is configured to transfer data from the outside world into the computer system 500. The input device 504 may include a touch sensing device configured to receive input from a user's touch and to send this information to the processor 510. In many cases, the touch-sensing device recognizes touches, as well as the position and magnitude of touches on a touch sensitive surface. The touch sensing means reports the touches to the processor 510 and the processor 510 interprets the touches in accordance with its programming. For example, the processor 510 may initiate a task in accordance with a particular touch. A dedicated processor can be used to process touches locally and reduce demand for the main processor of the computer system. The touch sensing device may be based on sensing technologies including but not limited to capacitive sensing, resistive sensing, surface acoustic wave sensing, pressure sensing, optical sensing, and/or the like. Furthermore, the touch sensing means may be based on single point sensing or multipoint sensing. Single point sensing is capable of only distinguishing a single touch, while multipoint sensing is capable of distinguishing multiple touches that occur at the same time.

In an illustrated embodiment, the input device 504 is a touch screen that is positioned over or in front of the display 502. The touch screen 670 may be integrated with the display device 502 or it may be a separate component. The touch screen 504 has several advantages over other input technologies such as touchpads, mice, and the like. For one, the touch screen 670 is positioned in front of the display 502 and therefore the user can manipulate the GUI directly. For example, the user can simply place their finger over an object to be selected, activated, controlled, and the like. In touch pads, there is no one-to-one relationship such as this. With touchpads, the touchpad is placed away from the display typically in a different plane. For example, the display is typically located in a vertical plane and the touchpad is typically located in a horizontal plane. This makes its use less intuitive, and therefore more difficult when compared to touch screens.

The touchscreen can be a single point or multipoint touchscreen. Multipoint input devices have advantages over conventional single point devices in that they can distinguish more than one object (finger) simultaneously. Single point devices are simply incapable of distinguishing multiple objects at the same time. In an example, a multipoint touch screen can also be used herein.

The computer system 500 also includes a proximity detection system 506 that is operatively coupled to the processor 510. The proximity detection system 506 is configured to detect when a finger (or stylus) is in close proximity to (but not in contact with) some component of the computer system including for example housing or I/O devices such as the display and touch screen. The proximity detection system 506 may be widely varied. For example, it may be based on sensing technologies including capacitive, electric field, inductive, hall effect, reed, eddy current, magneto resistive, optical shadow, optical visual light, optical IR, optical color recognition, ultrasonic, acoustic emission, radar, heat, sonar, conductive or resistive and the like. A few of these technologies will now be briefly described.

The computer system 500 also includes capabilities for coupling to one or more I/O devices 508. By way of example, the I/O devices 508 may correspond to keyboards, printers, scanners, cameras, speakers, and/or the like. The I/O devices 508 may be integrated with the computer system 500 or they may be separate components (e.g., peripheral devices). In some cases, the I/O devices 508 may be connected to the computer system 500 through wired connections (e.g., cables/ports). In other cases, the I/O devices 508 may be connected to the computer system 500 through wireless connections. By way of example, the data link may correspond to PS/2, USB, IR, RF, Bluetooth or the like.

The term “processor” as used herein include processing elements that are adapted to perform the recited operations, regardless of the number of physical elements. Thus, a processor can comprise all or part of one or more discrete components, integrated circuits, firmware code, and/or software code that receive electrical signals from touch sensor device 106 and cause the appropriate response on display screen 104. Processor 108 can be physically separate from touch sensor device 106 and display screen 104, as well as any part of electronic device 100; alternatively, processor 108 can be implemented integrally with any of these parts. In some embodiments, the elements that comprise processor 108 would be located with or near touch sensor device 106 and display screen 104. In other embodiments, some elements of processor 108 would be with touch screen interface 102 and other elements of processor 108 would reside elsewhere, such as on or near a distant electronic device 100. For example, processor 108 can reside at least partially on a processing system performing other functions for electronic device 100.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
visibly displaying a graphical user interface on a display of a computing device, the graphical user interface displaying a radially oriented first plurality of interface elements;
receiving, via the computing device, user input to scroll said first plurality of interface elements;
scrolling, via the computing device, said first plurality of interface elements based on the user input, said scrolling resulting in the display displaying the first plurality of interface elements as appearing to be rotating along a circumferential path; and
visibly displaying a radially oriented second plurality of interface elements, the display of the second plurality of interface elements resulting in the visual appearance that the first plurality of interface elements have rotated from a first position to a second position about a fixed axis of rotation.

2. The method of claim 1, wherein the displayed second plurality of interface elements comprises at least one interface element displayed within the first plurality of interface elements.

3. The method of claim 1, wherein the displayed second plurality of interface elements comprises interface objects not displayed within the first plurality of interface elements.

4. The method of claim 1, said scrolling further comprising:
visibly displaying each interface element of the first plurality of interface elements and the second plurality of interface elements at a respective scrolling angle to each immediately adjacent interface element in said pluralities.

5. The method of claim 4, wherein said respective scrolling angle is 7.5 degrees.

6. The method of claim 1, wherein said radial oriented display of the first plurality of interface elements and said radial oriented display of the second plurality of interface elements comprises:
visibly displaying the plurality of interface elements at a respective angle to an adjacently displayed interface element along the circumferential path.

7. The method of claim 6, wherein the respective angle is 15 degrees.

8. The method of claim 6, wherein each interface element is displayed as partially overlapping an adjacently displayed interface element.

9. The method of claim 1, further comprising:
determining a direction of the user input; and
scrolling the first plurality of interface elements in said direction so as to display the first plurality of interface elements as appearing to be rotating in said direction along the circumferential path.

10. The method of claim 1, further comprising:
determining a speed of the user input; and
scrolling the first plurality of interface elements so as to display the first plurality of interface elements as appearing to be rotating at said speed along the circumferential path.

11. The method of claim 1, further comprising:
determining a velocity of the user input; and
scrolling the first plurality of interface elements based on said velocity so as to display the first plurality of interface elements as appearing to be rotating in accordance with said velocity along the circumferential path.

12. The method of claim 1, wherein said computing device is a touch screen device comprising a touch screen, said user input comprising a user's interaction with the touch screen.

13. The method of claim 1, wherein at least one interface element of said plurality comprises:
a visibly displayed advertisement.

14. The method of claim 13, wherein said advertisement is displayed in accordance with said at least one interface element, content of said advertisement based upon content represented by the respective at least one interface element.

15. The method of claim 13, wherein said advertisement is an interface element visibly displayed adjacent to the at least one interface element, content of said advertisement based upon content represented by the respective at least one interface element.

16. A non-transitory computer-readable storage medium tangibly encoded with computer-executable instructions, that when executed by a computing device, perform a method comprising:
visibly displaying a graphical user interface on a display of a computing device, the graphical user interface displaying a radially oriented first plurality of interface elements;
receiving, via the computing device, user input to scroll said first plurality of interface elements;
scrolling, via the computing device, said first plurality of interface elements based on the user input, said scrolling resulting in the display displaying the first plurality of interface elements as appearing to be rotating along a circumferential path; and
visibly displaying a radially oriented second plurality of interface elements, the display of the second plurality of interface elements resulting in the visual appearance that the first plurality of interface elements have rotated from a first position to a second position about a fixed axis of rotation.

17. The non-transitory computer-readable storage medium of claim 16, wherein the displayed second plurality of interface elements comprises at least one interface element displayed within the first plurality of interface elements.

18. The non-transitory computer-readable storage medium of claim 16, wherein the displayed second plurality of interface elements comprises interface objects not displayed within the first plurality of interface elements.

19. The non-transitory computer-readable storage medium of claim 16, said scrolling further comprising:
visibly displaying each interface element of the first plurality of interface elements and the second plurality of interface elements at a respective scrolling angle to each immediately adjacent interface element in said pluralities.

20. The non-transitory computer-readable storage medium of claim 16, wherein said radial oriented display of the first plurality of interface elements and said radial oriented display of the second plurality of interface elements comprises:
visibly displaying the plurality of interface elements at a respective angle to an adjacently displayed interface element along the circumferential path.

21. The non-transitory computer-readable storage medium of claim 20, wherein each interface element is displayed as partially overlapping an adjacently displayed interface element.

22. The non-transitory computer-readable storage medium of claim 16, further comprising:
determining a characteristic of the user input; and
scrolling the first plurality of interface elements according to said characteristic so as to display the first plurality of interface elements as appearing to be rotating according to said characteristic along the circumferential path.

23. The non-transitory computer-readable storage medium of claim 22, wherein the characteristic is selected from a group consisting of direction, speed and velocity.

24. A computing device comprising:
a processor;
a storage medium for tangibly storing thereon program logic for execution by the processor, the program logic comprising:
logic executed by the processor for visibly displaying a graphical user interface on a display of a computing device, the graphical user interface displaying a radially oriented first plurality of interface elements;
logic executed by the processor for receiving, via the computing device, user input to scroll said first plurality of interface elements;
logic executed by the processor for scrolling, via the computing device, said first plurality of interface elements based on the user input, said scrolling resulting in the display displaying the first plurality of interface elements as appearing to be rotating along a circumferential path; and
logic executed by the processor for visibly displaying a radially oriented second plurality of interface elements, the display of the second plurality of interface elements resulting in the visual appearance that the first plurality of interface elements have rotated from a first position to a second position about a fixed axis of rotation.
